(19) United States
(12) Patent Application Publication
(10) Pub. No.: US 2023/0369668 A1
(43) Pub. Date: Nov. 16, 2023

(54) METHOD AND SYSTEM FOR RECOVERY OF ELECTRODE METALS FROM SPENT LITHIUM ION BATTERIES

(71) Applicant: AGR LITHIUM INC., Bellevue, WA (US)

(72) Inventors: Amol NAIK, Noida (IN); Rupesh SINGH, Noida (IN); Vipin TYAGI, Bellevue, WA (US); Nishchay CHADHA, Singapore (SG)

(73) Assignee: AGR LITHIUM INC., Bellevue, WA (US)

(21) Appl. No.: 18/197,910

(22) Filed: May 16, 2023

Related U.S. Application Data
(60) Provisional application No. 63/392,290, filed on Jul. 26, 2022.
(60) Provisional application No. 63/342,422, filed on May 16, 2022.

(51) Int. Cl. H01M 10/54; C22B 26/12; C22B 7/00

(52) U.S. Cl. CPC H01M 10/54; C22B 7/007; C22B 26/12

(57) ABSTRACT

A method of obtaining an electrode metal from an electrode of a lithium-ion (Li-ion) battery includes separating an electrode portion from a spent Li-ion battery. A leaching solvent is contacted to the separated electrode portion to form an electrode dispersion. The electrode dispersion is heated to a temperature in a range from about 50° C. to about 90° C. by applying microwave radiation. The temperature of the electrode dispersion is maintained to be in the range from about 50° C. to about 90° C. for a period in a range from about 10 seconds to about 5 minutes by further applying microwave radiation to the heated electrode dispersion. The electrode dispersion is then filtered to obtain the electrode metal.

### CROSS-REFERENCE TO RELATED APPLICATIONS

The present application the benefit of priority to U.S. Provisional Application No. 63/342,422, filed on May 16, 2022, and U.S. Provisional Application No. 63/392,290, filed on Jul. 26, 2022, each of which is incorporated herein by reference in its entirety.

### FIELD

The present disclosure relates generally to the field of recycling of spent lithium ion batteries, and in particular to systems and methods for recovery of electrode metals from spent lithium ion batteries.

### BACKGROUND

As the use of electric powered equipment including automobiles increases, the use of batteries continues to grow. Consequently, over time, the number of spent batteries will also grow. The amount of metals and other natural resources that are used as raw materials for batteries is, however, finite. Thus, to continue producing more batteries, the raw materials will need to be recovered by recycling spent batteries.

Typical lithium ion batteries include plastics, which form the protective cover for the battery and portions of the separator for the battery; anode, which includes an anode metal such as copper and black mass; cathode, which includes a cathode metal such as aluminum and black mass; and black mass which forms portions of the separator. The black mass generally includes graphite as well as oxides of several valuable metals such as iron, cobalt, manganese, nickel, copper and aluminum, in addition to lithium, which typically forms only about 1% of the battery weight.

Most current technologies for recycling spent lithium batteries utilize pyrometallurgical processes such as smelting which require high temperatures, e.g., in a range from about 500° C. to about 1400° C. Consequently, the cost of recovery of metals is substantially higher than the price of the recovered metals. Moreover, the amount of each metal recovered is also typically lower compared to, e.g., hydrometallurgical processes.

While hydrometallurgical processes can provide higher yields, and potentially higher purity of recovered metals, these processes generally require heating a leaching solvate for a long time at relatively higher temperatures, e.g., in a range from about 100° C. to about 400° C. Thus, the energy requirements of such processes remains high. Moreover, handling of high temperature leaching solvates poses certain hazards which further increase the cost of such processes.

Consequently, current technologies for recycling spent batteries is not cost-effective relative to the technology for obtaining these materials anew. Cost-effective, low energy, sustainable, and low carbon-footprint technologies for recovering materials from spent batteries are, therefore, needed.

### SUMMARY

The embodiments disclosed herein stem from the realization that high temperature and/or pyrochemical techniques are not necessary for recovering metals from the electrodes of a spent lithium ion battery. The present application discloses systems and methods for obtaining electrode metals from spent lithium ion batteries using a leaching solvent in the presence of an oxidizing agent. Because the leaching solvent used in the presently disclosed embodiments is an aqueous solution, microwave radiation can be utilized to reduce the time and energy required to heat the leaching solvent to a suitable temperature and to maintain the temperature at which the metals dissolve in the leaching solvent.

The leaching solvent of the presently disclosed embodiments is selected such that it can dissolve all the various metals used in a lithium ion battery. Thus, once the electrodes of a lithium ion battery are contacted with the leaching solvent at a suitable temperature, all the various metals from the battery are dissolved into the leaching solvent. Advantageously, the embodiments disclosed herein enable recovery of high purity electrode metals from a spent lithium ion battery without having to use a pyrochemical process, thereby substantially reducing the time, cost and carbon footprint for recovery of electrode metals from a lithium ion battery.

Accordingly, in at least one embodiment, a method of obtaining an electrode metal from an electrode of a lithium-ion (Li-ion) battery includes separating an electrode portion from a spent Li-ion battery. A leaching solvent is contacted to the separated electrode portion to form an electrode dispersion. The electrode dispersion is heated to a temperature in a range from 50° C. to 90° C. by applying microwave radiation. The temperature of the electrode dispersion is maintained to be in the range from 50° C. to 90° C. for a period in a range from 10 seconds to 10 minutes (e.g., 10 seconds, 30 seconds, 1 minute, 2 minutes, 3 minutes, 4 minutes, 5 minutes, 6 minutes, 7 minutes, 8 minutes, 9 minutes, 10 minutes, or any time between any two of these times) by further applying microwave radiation to the heated electrode dispersion. The electrode dispersion is then filtered to obtain the electrode metal.

In accordance with at least one embodiment, a system for recovery of electrode metals from spent lithium ion batteries includes a reaction chamber, a microwave radiation source coupled to the reaction chamber, a microwave controller coupled to the microwave radiation source, a temperature sensor coupled to the reaction chamber and the microwave controller and a filtration device coupled to the reaction chamber. The reaction chamber is configured to contain a leaching solvent and black mass from a spent lithium battery. The microwave radiation source is configured to heat the leaching solvent in the reaction chamber by providing a predetermined amount of microwave radiation power to the leaching solvent. The microwave controller receives a temperature measurement from the temperature sensor and controls the microwave radiation source to heat the leaching solvent in the reaction chamber to be in a range from 50° C. to 90° C. and maintain a temperature of the leaching solvent in the reaction chamber to be in a range from 50° C. to 90° C. for a period in a range from 10 seconds to 5 minutes. The filtration device is configured to filter the leaching solvent from the reaction chamber so as to separate the leaching solvent from undissolved black mass.

Additional features and advantages of the subject technology will be set forth in the description below, and in part will be apparent from the description, or may be learned by practice of the subject technology. The advantages of the subject technology will be realized and attained by the structure particularly pointed out in the written description and embodiments hereof as well as the appended drawings.

It is to be understood that both the foregoing general description and the following detailed description are exemplary and explanatory and are intended to provide further explanation of the subject technology.

### BRIEF DESCRIPTION OF THE DRAWINGS

Various features of illustrative embodiments of the present disclosure are described below with reference to the drawings. The illustrated embodiments are intended to illustrate, but not to limit, the present disclosure. The drawings contain the following figures:

FIG. 1 schematically shows an apparatus for recycling a spent lithium ion battery in accordance with at least some embodiments of the present disclosure.

FIG. 2 shows a flow chart for a method of obtaining electrode metal from an electrode of a spent lithium ion battery in accordance with at least some embodiments of the present disclosure.

### DETAILED DESCRIPTION

In the following detailed description, numerous specific details are set forth to provide a full understanding of the subject technology. It should be understood that the subject technology may be practiced without some of these specific details. In other instances, well-known structures and techniques have not been shown in detail so as not to obscure the subject technology.

Further, while the present description sets forth specific details of various embodiments, it will be appreciated that the description is illustrative only and should not be construed in any way as limiting. Additionally, it is contemplated that although particular embodiments of the present disclosure may be disclosed or shown in the context of recycling of certain types of lithium batteries such embodiments can be used with all types of lithium ion batteries. Furthermore, various applications of such embodiments and modifications thereto, which may occur to those who are skilled in the art, are also encompassed by the general concepts described herein.

A cathode for a typical lithium ion battery includes aluminum and a black mass, which comprises primarily of graphite powder and salts of one or more valuable metals such as lithium, cobalt, manganese, nickel, iron, and the like. Similarly, a typical anode for a lithium ion battery includes copper and black mass.

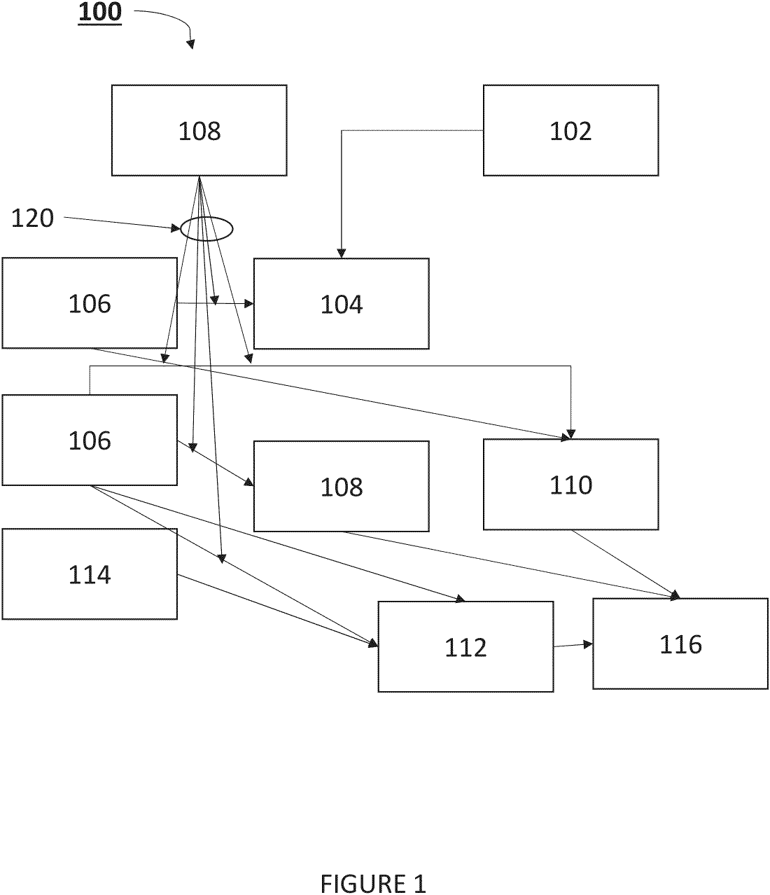

FIG. 1 shows a schematic diagram of an apparatus 100 for recycling a spent lithium ion battery in accordance with at least some embodiments of the present disclosure. In some embodiments, the apparatus 100 includes a crusher 102, a cleaning chamber 104, one or more chemical storage tanks 106, a controller 108, one or more reaction chambers such as, e.g., a separation chamber 110, a precipitation chamber 112, one or more clean water tanks 114, one or more recycled water tanks 116, and one or more pumps 120.

In some embodiments, the crusher 102 is designed to break a cell of a spent lithium ion battery (also referred to herein as “spent battery” for convenient reference) into pieces having a dimension in a range from about 1 mm to about 5 cm. In some embodiments, the crusher 102 may include a chamber that can be sealed and evacuated to reduce the amount of oxygen in the chamber, thereby preventing oxidation of the pieces of the spent battery. In some embodiments, the chamber may repressurized using an inert gas such as, for example, nitrogen or argon.

The cleaning chamber 104, in some embodiments, is designed to clean the pieces of the spent battery obtained from the crusher 102. Cleaning the pieces may include processes such as, for example, washing the pieces with water (e.g., distilled water), sonicating the pieces while in water or after drying the washed pieces, drying the washed and/or sonicated pieces, and the like.

In some embodiments, cleaning may be performed at room temperature or at an elevated temperature. In some embodiments, cleaning may be performed in air at atmospheric pressure. Alternatively or additionally, cleaning may be performed under a vacuum and/or in an inert atmosphere such as, for example, in presence of nitrogen, argon, or the like.

In some embodiments, cleaning the pieces may include dispersing the pieces of the spent battery in a fluid and filtering the pieces using one or more filtration processes such as, for example, using one or more meshes, each having a different mesh size. In some embodiments, the mesh size may range from about 50 µm to about 5 mm. For example, a filtration process may include sequential filtering of the dispersion through a mesh having a mesh size of about 5 mm, followed by filtering through a mesh having a mesh size of about 1 mm, followed by filtering through a mesh having a mess size of about 500 µm, followed by filtering through a mesh having a mess size of about 50 µm. In some embodiments, one or more of these steps may be omitted. Alternatively or additionally, one or more filtration steps may be added in the process.

In some embodiments, the one or more storage tanks 106 may store chemicals such as leaching chemicals, acids, neutralizing solutions (e.g., alkali solutions, acid solutions, salt solutions, etc.), water, and/or other proprietary solutions that include one or more chemicals useful in the recycling process.

In some embodiments, each of the one or more storage tanks 106 may be connected to one or more reaction chambers 110, 112. Further, the connection between a storage tank and a reaction chamber may include a control valve which can be controlled by a controller 108. The controller 108 is configured to control, via the control valve (or other mechanism), the amount of chemical transferred from the storage tank 106 to the reaction chamber 110, 112. For example, the controller 108 may control parameters such as, volume and/or flow rate of the chemical being transferred from the storage tank to the corresponding reaction chamber.

In some embodiments, the controller 108 may utilize a control parameter such as, for example, pH, temperature, volume, turbidity, density, and/or other parameters associated with the chemical in a given reaction chamber to control the volume, mass, and/or flow rate of the chemical being transferred from the storage tank to the given reaction chamber.

In some embodiments, the controller 108 may control the temperature of the material in the reaction chamber, e.g., by controlling the amount of heat delivered to the reaction chamber or the material within the reaction chamber. For example, in some embodiments, the controller 108 may control power output to a microwave generator coupled to the reaction chamber so as to control the microwave energy delivered to the material in the reaction chamber. The controller 108 may control the power output based on parameters such as, for example, the temperature of the material in the reaction chamber.

In some embodiments, the one or more reaction chambers may be connected to a clean water tank 114. The connection between the reaction chamber and the clean water tank may be controlled by a control valve in some embodiments. Similar to the connection between the reaction chambers and the storage tanks, the controller 108 may control, via the control valve, the amount of water transferred from the clean water tank 114 to the reaction chamber based on parameters such as pH, temperature, volume, turbidity, density, and/or other parameters associated with the chemical in a given reaction chamber.

The one or more reaction chambers are further connected to a recycled water tank 116 in some embodiments. Upon completion of the reaction in the reaction chamber, any solid material generated, e.g., precipitated and/or separated in the reaction chamber is removed. Solid material may be removed, e.g., by filtration. In some embodiments, the remainder of the chemical is neutralized using, e.g., a neutralizing solution which is introduced into the reaction chamber from a corresponding storage tank via control of a control valve by the controller. In some embodiments, any precipitate resulting from the neutralization reaction is removed, e.g., by filtration, and the remaining water is transferred to a recycled water storage tank 116.

In some embodiments, the transfer of material to or from one or more of the storage tanks 106, the reaction chambers 110, 112, the clean water tank 114 and/or the recycled water tank 116 may be facilitated by one or more pumps 120. In some embodiments, the one or more pumps 120 are coupled to the controller 108 which can control the one or more pumps 120 so as to control the rate of flow and/or volume of the material being transferred.

In an aspect of the present disclosure, a suitable apparatus such as, for example, the apparatus 100, may be utilized for recycling spent batteries. In particular, in some embodiments, an apparatus such as apparatus 100 may be utilized for recovering electrode metals, e.g., aluminum and/or copper, from spent batteries.

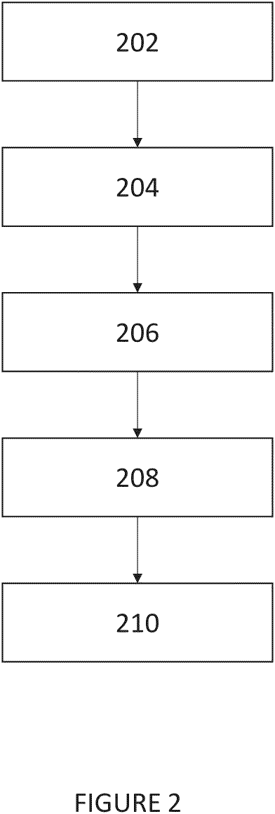

FIG. 2 illustrates a flow chart of a method 200 for recovering electrode metals from spent lithium ion batteries, in accordance with at least some embodiments of the present disclosure. The method 200 may include, at 202, separating an electrode from a crushed lithium ion battery. The separated electrode portion is contacted, at 204, with a leaching solvent to form an electrode dispersion. The electrode dispersion is heated, at 206, to a temperature in a range from about 50° C. to about 90° C. by applying microwave radiation to the electrode dispersion. At 208, the temperature of the heated electrode dispersion is maintained to be in a range from about 50° C. to about 90° C. for a period in a range from about 10 seconds to about 5 minutes via controlled application of microwave radiation. At 210, the electrode dispersion is filtered to obtain the electrode metal.

In some embodiments, separating the electrode portion from a crushed lithium ion battery, at 202, may include steps such as, for example, separation of the crushed portion via a sequence of sieves to separate material of different sizes. For example, in some embodiments, the separation may include separating coarse pieces having a size in a range from about 0.5 mm to about 5 mm by utilizing a suitable sieve, followed by further separating finer pieces having a size in a range from about 50 µm to about 0.5 mm by utilizing a second suitable sieve.

The separated pieces, e.g., coarse pieces, may be introduced in a reaction chamber where, at 204, the coarse pieces are contacted with a leaching solvent. In some embodiments, the leaching solvent may include an acid such as, for example, sulfuric acid, hydrochloric acid, oxalic acid, etc. In some embodiments, the leaching solvent may include more than one acid. In some embodiments, the leaching solvent may further include an oxidizing agent such as, for example, hydrogen peroxide or nitric acid. In some embodiments, the concentration of the leaching solvent acid may be in a range from about 0.5 N to about 10 N. In some embodiments, the leaching solvent may have a pH of about 0. In some embodiments, the pH of the leaching solvent may be in a range from about 0 to about 7.0. In some embodiments, the leaching solvent is introduced into the reaction chamber from a storage tank. The amount and rate of introduction of the leaching solvent may be controlled via a controller.

Table 1 provides the concentration for various materials used in the leaching solvent according to one example.

TABLE 1

specifications for leaching solvent according to an example.
Specifications of Leaching Solvent
Concentrations

| | |
|---|---|
| Sulfuric | 29% |
| L/S ratio | 10.00 |
| % of H₂O₂ | 3% |
| % of Proprietary reagent | 5% |

Upon introduction of the leaching solvent to the reaction chamber, the leaching solvent and the coarse pieces are stirred, e.g., using a stirrer (which may or may not be controlled by a controller), to form an electrode dispersion.

Microwave radiation is then applied, at 206, to the electrode dispersion so as to heat the electrode dispersion to a temperature in a range from about 50° C. to about 90° C. Thus, at 206, the electrode dispersion may be heated to a temperature of, e.g., about 50° C., about 55° C., about 60° C., about 65° C., about 70° C., about 75° C., about 80° C., about 85° C., about 90° C., or any temperature between any two of these values.

In some embodiments, the application of the microwave radiation is controlled by a controller which uses a temperature (e.g., determined using a temperature sensor coupled to the controller) in the reaction chamber as a feedback parameter. In some embodiments, the controller may be a proportional-integral-derivative (PID) controller, although other types of controllers are contemplated within the scope of the present disclosure.

In addition, in some embodiments, the electrode dispersion in the reaction chamber is stirred while being heated. Stirring of the electrode dispersion may be helpful in distributing the heat generated by application of microwave radiation more evenly through the electrode dispersion. Additionally or alternately, the electrode dispersion may be sonicate by application of, e.g., ultrasound, during the heating process.

Once the temperature of the electrode dispersion reaches a desired value, at 208, application of microwave radiation is continued so as to maintain the temperature at the desired value for a period in a range from about 10 seconds to about 5 minutes. For example, the temperature of the electrode dispersion may be maintained at the desired value for about 10 seconds, about 15 seconds, about 20 seconds, about 25 seconds, about 30 seconds, about 35 seconds, about 40 seconds, about 45 seconds, about 50 seconds, about 55 seconds, about 60 seconds, about 70 seconds, about 80 seconds, about 90 seconds, about 100 seconds, about 120 seconds, about 140 seconds, about 160 seconds, about 180 seconds, about 200 seconds, about 220 seconds, about 240 seconds, about 260 seconds, about 280 seconds, about 300 seconds or any amount of time between any two of these values.

In some embodiments, the continued application of microwave radiation at 208 is controlled using a controller such as, for example, the same controller used in 206. It will be appreciated that the continued application of microwave radiation does not necessary mean constant application of microwave radiation. Thus, in some embodiments, at 208, the microwave radiation may be applied in pulses. Each pulse may have a pulse width ranging from about 0.5 seconds to 5 seconds or longer. The microwave pulses may or may not have the same peak power. Thus, in some embodiments, the continued application of microwave radiation may include application of pulsed waves of microwave radiation and controlling parameters such as, for example, pulse width, peak power for the pulse, pulse rate and the total amount of time for which the microwave radiation is applied to the electrode dispersion.

In addition, at 208, the electrode dispersion may be stirred and/or sonicated using ultrasound so as to disperse the heat generated from application of microwave radiation more uniformly through the electrode dispersion.

After maintaining the temperature of the electrode dispersion for predetermined period of time, the electrode dispersion, at 210, the electrode dispersion is filtered. In some embodiments, the electrode dispersion may be cooled to room temperature prior to filtering at 210. In some embodiments, filtering the electrode dispersion may include passing the electrode dispersion through one or more filters, meshes or sieves. In some embodiments, the filters, meshes or sieves may be designed or selected to enable separation of solid matter having different sizes. For example, the a first mesh, filter or sieve may separate solid matter having a size greater than about 5 mm; a second mesh, filter or sieve may separate solid matter having a size in a range from about 1 mm to about 5 mm; a third mesh, filter or sieve may separate solid matter having a size in a range from about 0.5 mm to about 1 mm; a fourth mesh, filter or sieve may separate solid matter having a size in a range from about 100 µm to about 500 µm; a fifth mesh, filter or sieve may separate solid matter having a size in a range from about 10 µm to about 100 µm; a sixth mesh, filter or sieve may separate solid matter having a size in a range from about 1 µm to about 10 µm; and so forth.

In embodiments where the spent battery is crushed in such a way that pieces of the electrode portion have a size in a range from about 0.5 mm to about 5 mm, the filtration at 210 may be effective in separating pieces of cleaned electrode metal from the rest of the solid matter including black mass. It will be appreciated that the salts of valuable metals from the black mass dissolve in the leaching solvent, and the filtration process removes the insoluble portion of the black mass. Thus, the pieces of metal obtained following the filtration process may be pure metal with graphitic powder.

### EXAMPLES

Content of various materials found in different types of lithium ion batteries was analyzed. Tables 2-7 provide wt% of various material present in different types of lithium batteries in different portions of the batteries.

TABLE 2

Lithium Cobalt Oxide (LCO) batteries
LCO

| Components | % |
|---|---|
| With Respect to Scrap | |
| Aluminum | 8.00% |
| Copper | 17.00% |
| Graphite (anode) | 16.00% |
| Active cathode material | 24.00% |
| Lithium | 1.70% |
| Cobalt | 14.45% |
| Nickel | 0.00% |
| Aluminum | 0.00% |
| Oxygen | 7.85% |
| Al (foil particles) | 0.97% |
| Cu (foil particles) | 2.06% |
| Graphite | 38.79% |
| Lithium | 4.12% |
| Cobalt | 35.03% |
| Nickel | 0.00% |
| Aluminum | 0.00% |
| Oxygen | 19.03% |
| % of Al and Cu retained in black mass | 5.00% |

TABLE 3

Lithium Nickel Cobalt Aluminum (LNCA) batteries
LNCA

| Components | % |
|---|---|
| With Respect to Scrap | |
| Aluminum | 8.00% |
| Copper | 17.00% |
| Graphite (anode) | 16.00% |
| Active cathode material | 24.00% |
| Compositions in Active Mass | |
| Lithium | 1.73% |
| Cobalt | 2.20% |
| Nickel | 11.73% |
| Aluminum | 0.34% |
| Oxygen | 7.99% |
| Composition With Respect to Black Mass | |
| Al (foil particles) | 0.97% |
| Cu (foil particles) | 2.06% |
| Graphite | 38.79% |
| Lithium | 4.19% |
| Cobalt | 5.33% |
| Nickel | 28.43% |
| Aluminum | 0.82% |
| Oxygen | 19.37% |
| % of Al and Cu retained in black mass | 5.00% |

TABLE 4

Nickel Manganese Cobalt ⅓ proportion each in the active cathode (NMC111) batteries
NMC111

| Components | % |
|---|---|
| With Respect to Scrap | |
| Aluminum | 8.00% |
| Copper | 17.00% |
| Graphite (anode) | 16.00% |
| Active cathode material | 24.00% |
| Compositions in Active Mass | |
| Lithium | 1.73% |
| Cobalt | 4.89% |
| Nickel | 4.86% |
| Manganese | 4.56% |
| Oxygen | 7.96% |
| Composition With Respect to Black Mass | |
| Al (foil particles) | 0.97% |
| Cu (foil particles) | 2.06% |
| Graphite | 38.79% |
| Lithium | 4.19% |
| Cobalt | 11.85% |
| Nickel | 11.78% |
| Manganese | 11.05% |
| Oxygen | 19.30% |
| Other Variables | |
| % of Al and Cu retained in black mass | 5.00% |

TABLE 5

Nickel Manganese Cobalt 60/20/20% proportion each in the active cathode (NMC622) batteries
NMC622

| Components | % |
|---|---|
| With Respect to Scrap | |
| Aluminum | 8.00% |
| Copper | 17.00% |
| Graphite (anode) | 16.00% |
| Active cathode material | 24.00% |
| Compositions in Active Mass | |
| Lithium | 1.72% |
| Cobalt | 2.92% |
| Nickel | 8.72% |
| Manganese | 2.72% |
| Oxygen | 7.92% |
| Composition With Respect to Black Mass | |
| Al (foil particles) | 0.97% |
| Cu (foil particles) | 2.06% |
| Graphite | 38.79% |
| Lithium | 4.17% |
| Cobalt | 7.08% |
| Nickel | 21.14% |
| Manganese | 6.59% |
| Oxygen | 19.20% |
| Other Variables | |
| % of Al and Cu retained in black mass | 5.00% |

TABLE 6

Nickel Manganese Cobalt 80/10/10% proportion each in the active cathode (NMC811) batteries
NMC811

| Components | % |
|---|---|
| With Respect to Scrap | |
| Aluminum | 8.00% |
| Copper | 17.00% |
| Graphite (anode) | 16.00% |
| Active cathode material | 24.00% |
| Compositions in Active Mass | |
| Lithium | 1.71% |
| Cobalt | 1.46% |
| Nickel | 11.58% |
| Manganese | 1.36% |
| Oxygen | 7.89% |
| Al (foil particles) | 0.97% |
| Cu (foil particles) | 2.06% |
| Graphite | 38.79% |
| Lithium | 4.15% |
| Cobalt | 3.54% |
| Nickel | 28.07% |
| Manganese | 3.30% |
| Oxygen | 19.13% |
| % of Al and Cu retained in black mass | 5.00% |

TABLE 7

Lithium Iron Phosphate (LFP) batteries
LFP

| Components | % |
|---|---|
| With Respect to Scrap | |
| Aluminum | 8.00% |
| Copper | 17.00% |
| Graphite (anode) | 15.30% |
| Active cathode material | 22.20% |
| Compositions in Active Mass | |
| Lithium | 0.98% |
| Iron | 7.86% |
| Phosphorus | 4.35% |
| Oxygen | 9.00% |
| Composition With Respect to Black Mass | |
| Al (foil particles) | 1.032% |
| Cu (foil particles) | 2.19% |
| Graphite | 39.48% |
| Lithium | 2.53% |
| Iron | 20.28% |
| Phosphorus | 11.23% |
| Oxygen | 23.23% |
| Other Variables | |
| % of Al and Cu retained in black mass | 5.00% |

100 kg of LCO, LNCA, NMC622, and LFP (25 wt% contribution) batteries were recycled using the method disclosed herein to recover electrode metals.

Table 8 provides the amount electrode metals recovered following the process.

TABLE 8

Amounts of metal (salts) recovered after precipitation.

| Compounds | Amount (kg) |
|---|---|
| FePO₄ | 13.53 |
| Al(OH)₃ | 3.34 |
| C⁰CO₃ | 23.22 |
| CuCO₃ | 3.95 |
| MnCO₃ | 3.35 |
| NiCO₃ | 24.31 |
| Li₂CO₃ | 38.7 |

### FURTHER CONSIDERATIONS

In some embodiments, any of the clauses herein may depend from any one of the independent clauses or any one of the dependent clauses. In one aspect, any of the clauses (e.g., dependent or independent clauses) may be combined with any other one or more clauses (e.g., dependent or independent clauses). In one aspect, a claim may include some or all of the words (e.g., steps, operations, means or components) recited in a clause, a sentence, a phrase or a paragraph. In one aspect, a claim may include some or all of the words recited in one or more clauses, sentences, phrases or paragraphs. In one aspect, some of the words in each of the clauses, sentences, phrases or paragraphs may be removed. In one aspect, additional words or elements may be added to a clause, a sentence, a phrase or a paragraph. In one aspect, the subject technology may be implemented without utilizing some of the components, elements, functions or operations described herein. In one aspect, the subject technology may be implemented utilizing additional components, elements, functions or operations.

The subject technology is illustrated, for example, according to various aspects described below. Various examples of aspects of the subject technology are described as numbered clauses (1, 2, 3, etc.) for convenience. These are provided as examples and do not limit the subject technology. It is noted that any of the dependent clauses may be combined in any combination, and placed into a respective independent clause, e.g., clause 1 or clause 5. The other clauses can be presented in a similar manner.

Clause 1. A method of obtaining a metal from an electrode of a lithium-ion (Li-ion) battery, the method comprising: separating an electrode portion from a crushed Li-ion battery; contacting a leaching solvent to the separated electrode portion to form an electrode dispersion; heating the electrode dispersion to a temperature in a range from 50° C. to 90° C. by applying microwave radiation; maintaining the temperature of the electrode dispersion in the range from 50° C. to 90° C. for a period in a range from 10 seconds to 5 minutes by further applying microwave radiation to the heated electrode dispersion; and filtering the electrode dispersion to obtain the metal.

Clause 2. The method of clause 1, wherein the metal comprises one of aluminum, copper, and iron.

Clause 3. The method of clause 1, wherein the leaching solvent comprises sulfuric acid.

Clause 4. The method of clause 1, wherein the leaching solvent has a pH in a range from 0 to 7.0

Clause 5. The method of clause 1, wherein heating the electrode dispersion further comprises stirring the electrode dispersion while applying the microwave radiation.

Clause 6. The method of clause 1, wherein maintaining the temperature of the electrode dispersion comprises controlling application of the microwave radiation using a controller.

Clause 7. The method of clause 1, wherein heating the electrode dispersion comprises heating the electrode dispersion to a temperature in a range from 60° C. to 80° C.

Clause 8. The method of clause 1, wherein maintaining the temperature comprises maintaining the temperature of the electrode dispersion in a range from 60° C. to 80° C., for a period in a range from 30 seconds to 5 minutes.

Clause 9. The method of clause 1, wherein the electrode portion comprises the electrode metal, and a black mass comprising graphite and metal oxides.

Clause 10. The method of clause 9, wherein filtering the electrode dispersion comprises filtering the electrode dispersion through a sieve to obtain a graphite powder.

Clause 11. The method of clause 1, wherein heating the electrode dispersion further comprises continuously stirring the electrode dispersion while applying the microwave radiation.

Clause 12. The method of clause 1, wherein maintaining the temperature of the electrode dispersion further comprises continuously stirring the electrode dispersion while applying the microwave radiation.

Clause 13. A system for recycling a spent lithium ion battery, the system comprising: a crusher configured to break a cell of the spent lithium ion battery into pieces; a cleaning chamber configured to clean the pieces; one or more storage tanks configured to store chemicals; one or more reaction chambers coupled to the one or more storage tanks via one or mor pumps and valves, at least one of the one or more reaction chambers being coupled to a microwave generator configured to provide microwave radiation to reactants in the at least one reaction chamber; and a controller. The controller is configured to control: the one or more pumps and/or the one or more valves to modulate rate of transfer and amount of chemicals being transferred from the one or more storage tanks to a corresponding of the one or more reaction chambers, and the microwave generator to modulate an amount of microwave radiation provided to the at least one reaction chamber so as to heat the reactants in the at least one reaction chamber to a temperature in a predetermined range, and maintain the temperature of the reactants to be in the predetermined range for a predetermined period of time. The cleaned pieces are disposed in a first of the one or more reaction chambers to be contacted with a leaching solvent, the first reaction chamber being among the at least one reaction chambers coupled to the microwave generator.

Clause 14. The system of clause 13, wherein at least one of the one or more reaction chambers includes a stirrer configured to stir the reactants therein.

Clause 15. The system of clause 13, wherein the crusher comprises a chamber configured to be maintained under vacuum and/or have an inert atmosphere.

Clause 16. The system of clause 13, wherein the leaching solvent comprises sulfuric acid and an oxidizing agent.

Clause 17. The system of clause 13, wherein the predetermined temperature range is from 50° C. to 90° C.

Clause 18. The system of clause 13, wherein the predetermined period of time is in a range from 10 seconds to 5 minutes.

Clause 19. The system of clause 13, wherein the leaching solvent has a pH in a range from 0 to 7.0.

Clause 20. The system of clause 13, wherein maintaining the temperature comprises maintaining the temperature of the electrode dispersion in a range from 60° C. to 80° C., for a period in a range from 30 seconds to 5 minutes.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

As used herein, the term “about” preceding a quantity indicates a variance from the quantity. The variance may be caused by manufacturing tolerances or may be based on differences in measurement techniques. The variance may be up to 10% from the listed value in some instances. Those of ordinary skill in the art would appreciate that the variance in a particular quantity may be context dependent and thus, for example, the variance in a dimension at a micro or a nano scale may be different than variance at a meter scale.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Terms such as “top,” “bottom,” “front,” “rear” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

Furthermore, to the extent that the term “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

What is claimed is:

1. A method of obtaining a metal salt from a spent lithium-ion (Li-ion) battery, the method comprising:
separating an electrode portion from a crushed Li-ion battery;
contacting a leaching solvent to the separated electrode portion to form an electrode dispersion;
heating the first dispersion to a temperature in a range from 50° C. to 90° C. by applying microwave radiation;
maintaining the temperature of the first dispersion in the range from 50° C. to 90° C. for a period in a range from 10 seconds to 5 minutes by further applying microwave radiation to the heated first dispersion;
filtering the electrode dispersion to obtain the metal.

2. The method of claim 1, wherein the metal comprises one or iron, aluminum, and copper.

3. The method of claim 1, wherein the leaching solvent comprises sulfuric acid.

4. The method of claim 3, wherein the leaching solvent further comprises an oxidizing agent.

5. The method of claim 4, wherein the oxidizing agent is hydrogen peroxide.

6. The method of claim 1, wherein the leaching solvent has a pH in a range from 0 to 7.0.

7. The method of claim 1, wherein heating the electrode dispersion further comprises stirring the electrode dispersion while applying the microwave radiation.

8. The method of claim 1, wherein maintaining the temperature of the electrode dispersion comprises controlling application of the microwave radiation using a controller.

9. The method of claim 1, wherein heating the electrode dispersion comprises heating the electrode dispersion to a temperature in a range from 60° C. to 80° C.

10. The method of claim 1, wherein maintaining the temperature comprises maintaining the temperature of the electrode dispersion in a range from 60° C. to 80° C., for a period in a range from 30 seconds to 5 minutes.

11. The method of claim 1, wherein the electrode portion comprises the electrode metal, and a black mass comprising graphite and metal oxides.

12. The method of claim 11, wherein filtering the electrode dispersion comprises filtering the electrode dispersion through a sieve to obtain a graphite powder.

13. The method of claim 1, wherein heating the electrode dispersion further comprises continuously stirring the electrode dispersion while applying the microwave radiation.

14. The method of claim 1, wherein maintaining the temperature of the electrode dispersion further comprises continuously stirring the electrode dispersion while applying the microwave radiation.

15. A system for recycling a spent lithium ion battery, the system comprising:
a crusher configured to break a cell of the spent lithium ion battery into pieces;
a cleaning chamber configured to clean the pieces;
one or more storage tanks configured to store chemicals;
one or more reaction chambers coupled to the one or more storage tanks via one or mor pumps and valves, at least one of the one or more reaction chambers being coupled to a microwave generator configured to provide microwave radiation to reactants in the at least one reaction chamber; and
a controller configured to control:
the one or more pumps and/or the one or more valves to modulate rate of transfer and amount of chemicals being transferred from the one or more storage tanks to a corresponding of the one or more reaction chambers, and
the microwave generator to modulate an amount of microwave radiation provided to the at least one reaction chamber so as to heat the reactants in the at least one reaction chamber to a temperature in a predetermined range, and maintain the temperature of the reactants to be in the predetermined range for a predetermined period of time,
wherein the cleaned pieces are disposed in a first of the one or more reaction chambers to be contacted with a leaching solvent, the first reaction chamber being among the at least one reaction chambers coupled to the microwave generator.

16. The system of claim 15, wherein at least one of the one or more reaction chambers includes a stirrer configured to stir the reactants therein.

17. The system of claim 15, wherein the crusher comprises a chamber configured to be maintained under vacuum and/or have an inert atmosphere.

18. The system of claim 15, wherein the leaching solvent comprises sulfuric acid.

19. The system of claim 15, wherein the predetermined temperature range is from 50° C. to 90° C.

20. The system of claim 15, wherein the predetermined period of time is in a range from 10 seconds to 5 minutes.

21. The system of claim 15, wherein the leaching solvent has a pH in a range from 0 to 7.0.

22. The system of claim 15, wherein maintaining the temperature comprises maintaining the temperature of the electrode dispersion in a range from 60° C. to 80° C., for a period in a range from 30 seconds to 5 minutes.
